(19) United States
(12) Patent Application Publication
(10) Pub. No.: US 2006/0010149 A1
(43) Pub. Date: Jan. 12, 2006

(54) Method and system for computer-implemented processing of data sets

(75) Inventor: Rainer Mattern, Waldsee (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/158,067

(22) Filed: Jun. 22, 2005

(30) Foreign Application Priority Data
Jun. 23, 2004 (DE) 102004031931.6

(51) Int. Cl. G06F 17/30

(52) U.S. Cl. 707/101

(57) ABSTRACT

Method, system and computer program product for processing planning-relevant data sets, in which planning-relevant data sets from different tables of at least one databank with operative planning data are input into a central table which comprises a central quantity field and/or a central date field, and on the basis of the central table obtained a multi-dimensional data cube is generated and stored in a central memory of a network system, and wherein, for evaluation, the multi-dimensional data cube is loaded from the central memory into a front-end application.

### SUMMARY OF THE BACKGROUND

1. Field of the Invention

The present invention relates to a computer-implemented method, system and computer program product for processing data sets. In particular, the invention relates to a method and system for the automated support of reporting and simulation in the planning of sales, production and procurement in a company or business.

2. Description of the Related Art

In planning processes in businesses, a distinction has to be drawn between strategic, operational and tactical planning.

Strategic planning is generally carried out company-wide, annually, looking ahead over a number of years and often monetarily (i.e. in financial terms). As during this course planning, compressed data sets have to be evaluated quickly and from different aspects, office applications, e.g. table calculation program such as Microsoft Excel® are frequently used.

Operational, i.e. executive planning generally takes place daily and weekly looking ahead over a number of days or weeks. This is fine planning in which, generally, ERP Systems (Enterprise Resource Planning Systems) such as for example SAP/R3® are used. These systems support operational planning in relation to the business, at the lowest level of the range of goods hierarchy, i.e. at the individual item level, and purely in quantitative terms.

Tactical planning combines strategic and operational planning. It is generally carried out monthly, looking ahead over a number of months. Since tactical planning mediates between the strategic and operational levels, detailed data of the ERP-Systems have to be available, which, when viewed in compacted form, provide a simple comparison for strategic planning.

At the same time, tactical planning ranges over the various functions, as on the one hand strategies and operations and on the other hand different business units, e.g. marketing, sales, material economics and production, are involved. Moreover, the tactical planning process may span the entire company, as a result of production and marketing networks. A schematic graphic representation of the three planning levels described above is shown in FIG. 1.

It will be appreciated that hitherto there have been no data processing systems and programmes available which support the planning function at a tactical level in businesses.

### SUMMARY OF THE INVENTION

Accordingly, one object of the present invention is a method for processing planning-relevant records. The method includes inputting first planning-relevant records from different tables into a data bank stored in memory of a computer system. The table in the data bank is processed to provide a multi-dimensional data cube that is stored in the central memory of a network system and from which data may be loaded into a front end application.

An embodiment of the invention includes a computer system for processing planning-relevant records. The computer system may include a central computer and a central memory for storing and processing a data bank containing operational planning data. One or more client computers implementing a front end application may be internetworked with the central computer. Data are inputted into a central table in the system and may be ordered by a quantity and/or a date field to provide a central table from which a multi-dimensional data cube is generated and stored in central memory. The multi-dimensional data cube may then be accessed by or loaded into one or more front end applications.

### BRIEF DESCRIPTION OF THE DRAWINGS

The invention is hereinafter schematically illustrated by means of an exemplifying embodiment shown in the drawings and is described in detail with reference to said drawings.

FIG. 1 schematically shows the three planning levels of strategic, operational and tactical planning.

FIG. 2 shows an empty core table into which the planning related records are input.

FIG. 3 shows a company-or-business-wide system table with planning related records for inputting into the core table in FIG. 2.

FIG. 4 shows the core table in FIG. 2 after stock data from the table in FIG. 3 have been input.

FIG. 5 shows a order table with planning related records for further inputting into the core table in FIG. 4.

FIG. 6 shows the core table in FIG. 4 after the inputting of order data from the table in FIG. 5.

FIG. 7 shows a forecast table as another table containing planning related records for inputting into the core table in FIG. 6.

FIG. 8 shows an additional table to the forecast table in FIG. 7.

FIG. 9 shows the core table in FIG. 6 after the inputting of forecast data from the forecast table in FIG. 7 and the additional table in FIG. 8.

FIG. 10 shows an example of the dimension “origin” for expanding the core table and generating a multi-dimensional data cube.

FIG. 11 shows an example of the dimension “time bar” for expanding the core table and generating a multi-dimensional data cube.

FIG. 12 shows an example of a pivot table for evaluating the multi-dimensional data cube generated.

FIG. 13 shows a computer system for implementing the invention.

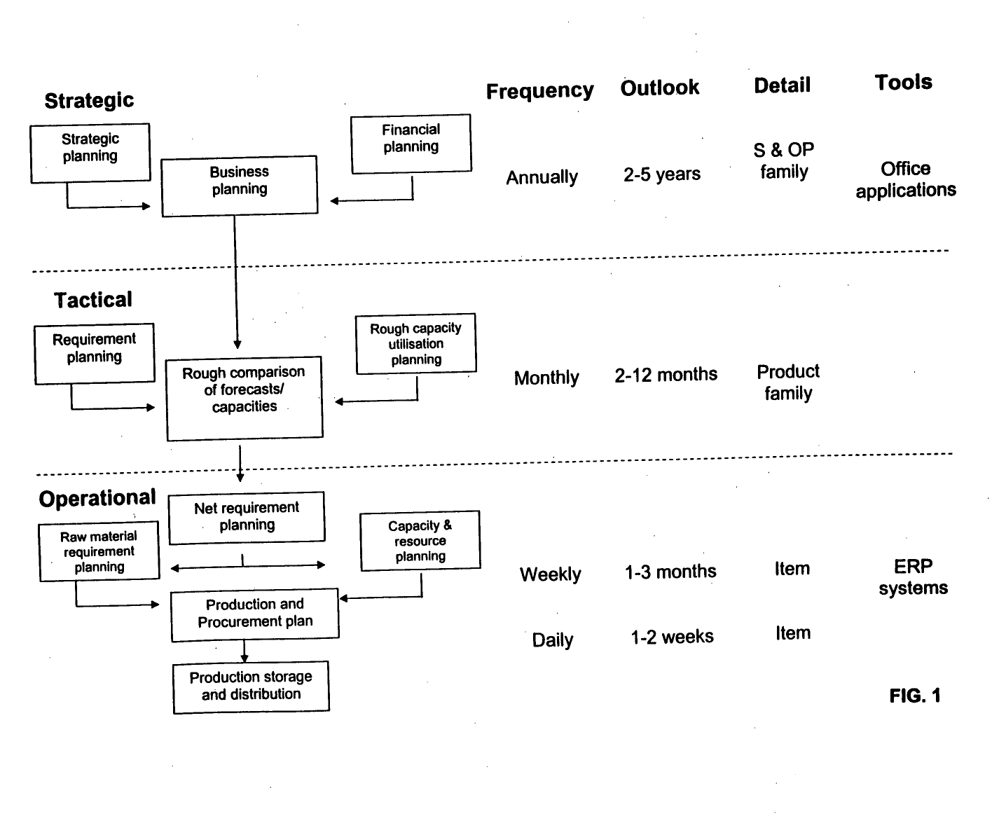

### DETAILED DESCRIPTION OF THE INVENTION

In one embodiment a process according to the invention is used for processing and evaluating planning-relevant data sets or records, preferably in the field of tactical planning.

In operative ERP-Systems, planning-relevant data may exist in functionally divided and generally company-specific systems and system tables.

Business Warehouse Systems may also be divided up according to functional aspects, i.e. information on stock levels, orders, sales figures, forecasts, budgets, production quantities, orders, etc. are stored in separate system tables.

All the planning-relevant information is input according to the invention, in a first processing step, from the numerous ERP-System tables into a central table, hereinafter referred to as the core table.

In contrast with known approaches in which data sets or records from only one area of function are shown, the invention is based on the realisation or conclusion that planning related data from all the functional areas can be provided by abstraction in one table, the so called core table.

The basic structure of the core table is derived in principle from the question “What is relevant to the planning process, how, when, where and in what quantities?”.
What: What item of the goods hierarchy is involved (=for example Article)?
How: What element is involved (=Origin, e.g. “Order”, “Contract”, “Forecast” and “Description”)?
When: At what time is the planning element relevant (=Date)?
Where: In which organisational unit or geographic location is the element relevant (e.g. Business, Works, Region, Country)?
How much: In what amount is the element relevant to planning in the organisational unit or geographic location?

Planning includes calculating changes in quantity over a time axis. Therefore, in one aspect, of the invention the core table is a restriction to a planning-relevant date field and a planning-relevant quantity field. The two fields are hereinafter referred to as the “central quantity field” and “central date field”. Other fields may be included but preferably the invention process includes only the planning-relevant date and planning-relevant quantity as essential fields. The other fields may be included as separate essential fields in additional to the planning- and date-relevant fields but are preferably not included as essential fields.

The central date field contains the planning-relevant date of the particular element. All the other date fields which are not relevant to planning (such as for example the date of issue, date of billing, delivery date, client request date) are regarded simply as additional information in the description of the element. The central quantity field contains the planning-relevant quantity of the element in question. All the other quantity fields which are not relevant to planning (such as for example the delivery quantity, client request quantity, freely available stock) are similarly regarded merely as additional information in the description of the element.

The inputting of the records into the core table may be carried out in accordance with the following rules:
Only planning-relevant records are taken into consideration. Any records which are not relevant from a planning point of view are discarded.
The planning related records are input on a detailed level.
The planning related quantity may be entered in the central quantity field while the planning related date may be entered in the central date field. Other quantity and date fields may expand the description of the planning related element.
The planning related quantity is sign-sensitive. Planning related acquisitions have a positive sign while planning related outgoings have a negative sign.
Records relevant to planning in a number of respects may be input several times. In this way, two or more records on a planning-relevant event are stored in the core table.

Thus, according to one embodiment of the invention, to assist with tactical planning, planning-relevant records spanning businesses and functions are provided within a single table, the so called core table.

In a second processing step of an embodiment of the invention, based on the core table, a multi-dimensional data cube is generated which is made up of the planning related records of a business group. The second processing step may be carried out immediately after a first processing step or may be carried out after one or more processing steps have been carried out after the first processing step. Preferably, the second processing step is carried out after the first processing step. Processing steps that may be carried out before the second processing step and after the first processing step include, for example, a data ordering step wherein the data of the table is organized sequentially and other processing steps such as derivitizing information of the central quantity field and/or central date field to provide new fields or provide data in the original central quantity and central date fields that have undergone mathematical calculation and/or manipulation. In a preferred embodiment the core table is made up of all of the planning related records of a business group.

The data cube according to the invention has typical dimensions such as materials, organisation or time. Preferably the data cube has dimensions that consist essentially of the origin and time bar of the specified dimensions. In a particularly preferred embodiment the data cube is characterized only by the origin and time bar of the specified dimensions.

The generation of these two dimensions will now be described.

The core table contains detailed information as to the origin of a record. By means of this field and an additional table, the dimension of origin with different features and emphasis is generated in the data cube.

The assigning of the records to the dimension of time bar is carried out according to the rules relating to origin and the central date field. The following rules apply, inter alia:
planning-relevant elements from the functional areas of material economics and production (e.g. undelivered customer orders, open production orders), which occur before the start of the time bar, are assigned to the starting point of the time bar.
planning-relevant elements from the functional areas of sales and marketing (e.g. budgets, forecasts, sales history) which occur before the start of the time bar are not assigned to this time bar.
planning-relevant elements of all functions occurring after the end of the time bar are not assigned to it.

Any number of additional other rules may apply. There is no restriction on the type of rules or the type of calculations which may be used to assign records to the dimension of the time bar.

The contents of the data cube may be expanded to include various calculated and balance-sheet evaluations of the central quantity field, for example relating to manufacturing or replacement costs.

The invention thus relates to a multi-dimensional data cube which provides the planning-relevant records with dimensions of origin and time bar.

In a third processing step, planning relevant records are loaded into a front end application, such as Microsoft Excel®. In the front end application the records undergo calculation and/or derivitization and may be evaluated and displayed in various planning aspects.

Of course, the invention also includes computer programmes with programme coding means which are suitable for executing a method according to the invention when the computer programme is run on a computer, and also computer readable data carrier media with computer programmes according to the invention stored thereon, and computer programme products with computer-readable data carrier media of this kind.

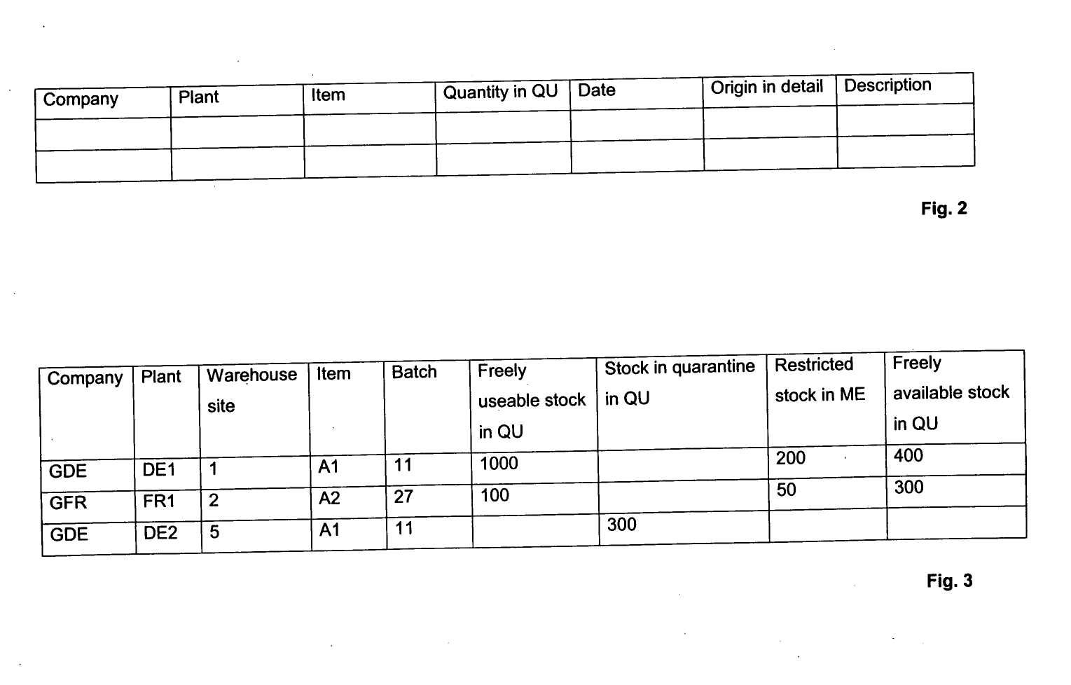

Referring now to FIGS. 2 to 9, the inputting of the records from different system tables to produce the core table according to the invention will be described by way of example. The sequence of inputting, the tables shown containing data relevant to the planning process and the inputting rules used are also provided by way of example.

FIG. 2 shows a blank core table into which records relevant to the planning process are input. A core table of this design is suitable, for example, for businesses which manufacture and market goods in various companies and plants. The individual columns of the core table may include: “Company” (=Business), “Plant”, “Goods” (=Product), “Quantity in QU” (QU=Quantity units), “Date”, “Origin” and “Description”.

In a multi-stage distribution structure, a differentiation may be made in the core table between a “producing company” and a “marketing company”. As will be apparent, the core table according to the invention has in each case one date field and one quantity field. These are the central date field and the central quantity field. In a particularly preferred embodiment the core table contains only one date field and only one quantity field.

FIG. 3 shows a system table spanning the companies with stock data on a given random date, i.e. 15 Feb. 2004 in the example shown.

The data contents available in the table by way of example are “Company”, “Plant”, “Warehouse site”, “Item”, “Batch”, “Freely useable stocks in QU”, “Stocks in quarantine in QU”, “Restricted stocks in QU” and “Freely available stocks in QU”.

The first record in the stock table contains stock data for Batch 11 of Item A1 in the plant DE1 of the company GDE.

The free stock of 1000 kg is immediately useable in planning terms. Therefore the quantity 1000 kg is input into the central quantity field and the relevant date of 15 Feb. 2004 is entered in the central date field of the core table. For details of origin the record in the core table is given as “free stock” and is described as “free stock, warehouse 1, batch 11”. The information as to the warehouse and batch, for which no columns are provided in the core table, are included in the description and thus are not lost. However, during subsequent evaluation, it is not possible to obtain a breakdown according to warehouse or batch. If the information “warehouse site” is relevant to a business in technical planning, the core table must be expanded to include a column for warehouse site. Expanding the core table to include a column headed “batch” is not expedient as tactical planning at the batch level is not possible.

The first record in the stock table contains another piece of information relevant to the planning process, a restricted stock of 200 kg. Therefore, another line of data is produced in the core table.

The quantity of 200 kg is entered in the central quantity field of the second line of data, while a date far in the future (31.12.2050 in this embodiment) is entered in the central date field, as restricted stock for the business in the illustration need only be taken into consideration in the long term.

Calculated quantities in the stock table, such as a freely available quantity (=freely useable stock minus stock which has already been assigned to an order), are not input into the core table.

Analogously, from the second record in the stock table, records 3 and 4 of the core table are produced. Only one record is produced in the core table from the third record in the stock table, as it contains only stock in quarantine in an amount of 300 kg.

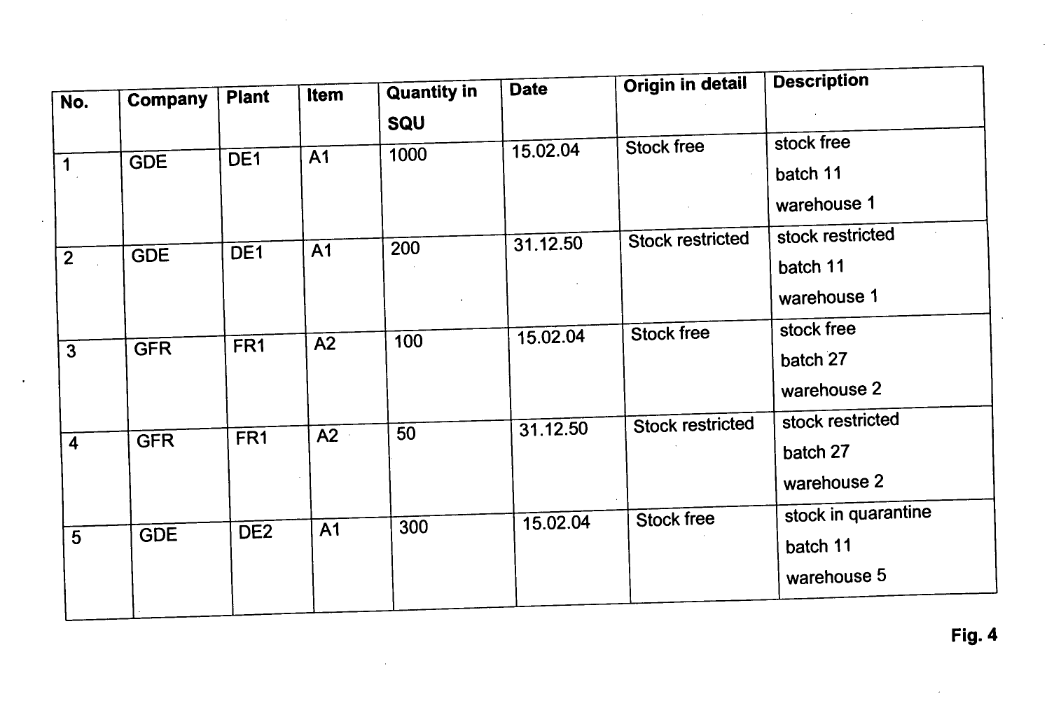

The core table filled with stock data as of 15 Feb. 2004 is shown in FIG. 4.

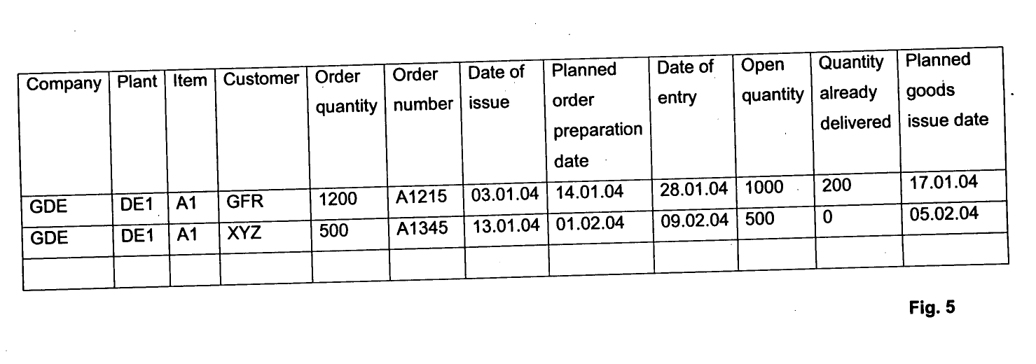

FIG. 5 shows an order table on the relevant date of 15 Feb. 2004, the contents of which are also input into the core table.

The columns “order number” and “customer” in the order table do not exist in the core table, like the warehouse site and batch. Both pieces of information are entered in the field “description”. What is relevant to the planning process is the goods outward date as there will be a reduction in quantity on this date. The goods outward date is therefore entered in the central date field. The other date fields are not relevant to the planning process and are partly included in the description. The open quantity is relevant to the planning, but not the quantity delivered or the original quantity ordered. For this reason, only the open quantity is entered in the central quantity field of the core table.

The top-up order in the embodiment shown from company GDE to company GFR is relevant to the planning process in two respects. It constitutes an element of outgoings for the company GDE but for the company GFR it constitutes an acquisition, at a later date. The top-up order therefore appears in the core table as both an acquisition and an outgoing, on the one hand to the destination plant DE1 and on the other hand to the originating plant FR1. In line 8 the customer order for customer XYZ is input from the second line of the order table.

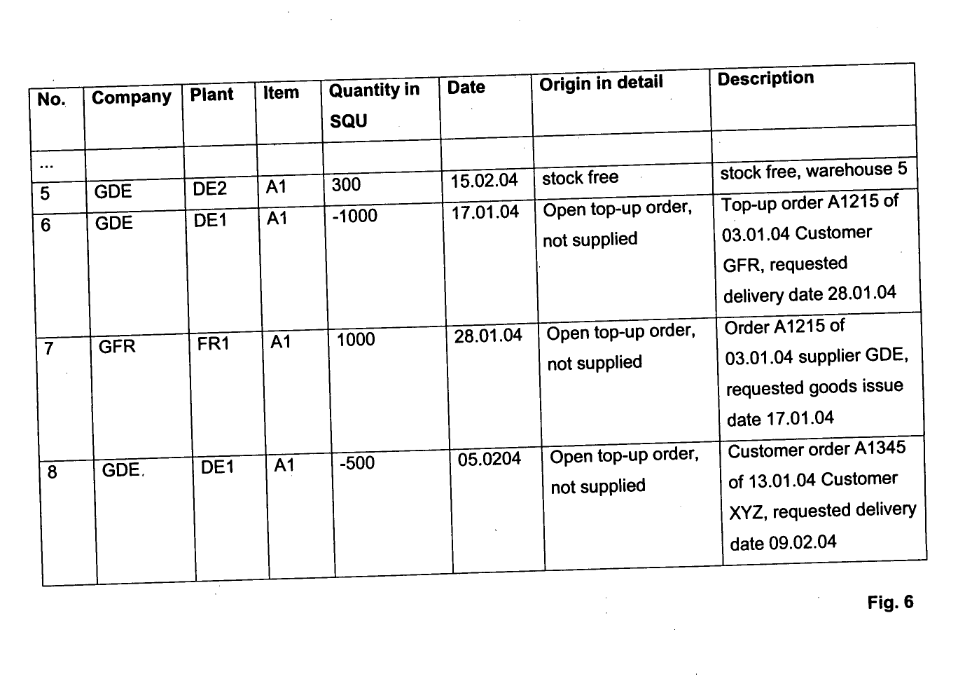

The results of inputting the data from the order table into the core table are shown in FIG. 6. For reasons of clarity the first four records already known have been omitted and to illustrate the transition from stock data to order data the fifth record is shown in italics. The records originating from different system tables have been stored smoothly, i.e. seamless, one after the other in the core table.

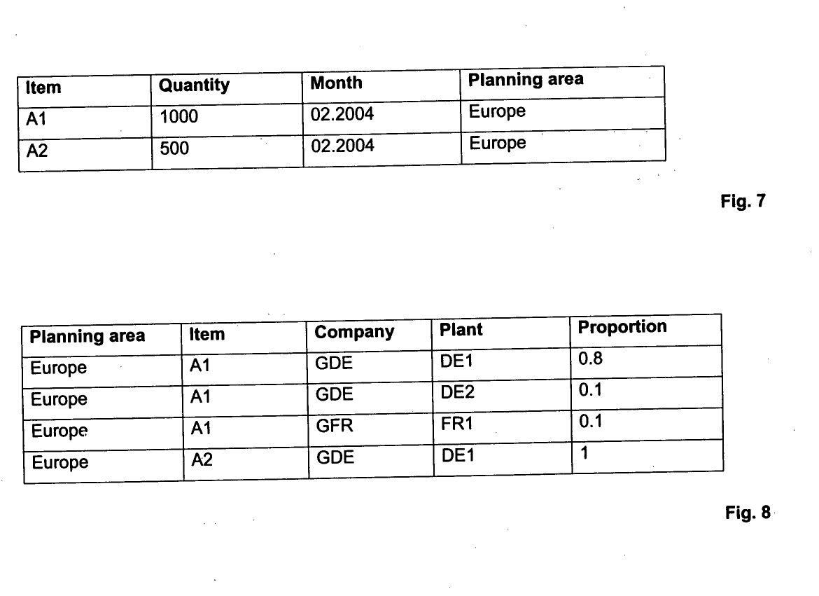

FIG. 7 shows another table which contains planning-relevant records and is to be entered in the core table. This is a forecast table, again relating to the date of 15 Feb. 2004.

The columns in the forecast table are “Item”, “Quantity”, Month” and “Planning area”. The contents serve to allow future requirements to flow into the planning process.

As the forecast table does not contain any information as to the coding of the requirements to companies and plants, an additional table as shown in FIG. 8 is needed. This table comprising the columns headed “Planning area”, “Items”, “Company”, “Plant” and “Percentage”, as a supplement to the forecast table contains information as to what percentage requirement has to be covered by which company and which plant.

The records in the forecast table are input into the core table, taking the additional table into account, analogously to the method according to the invention described hereinbefore.

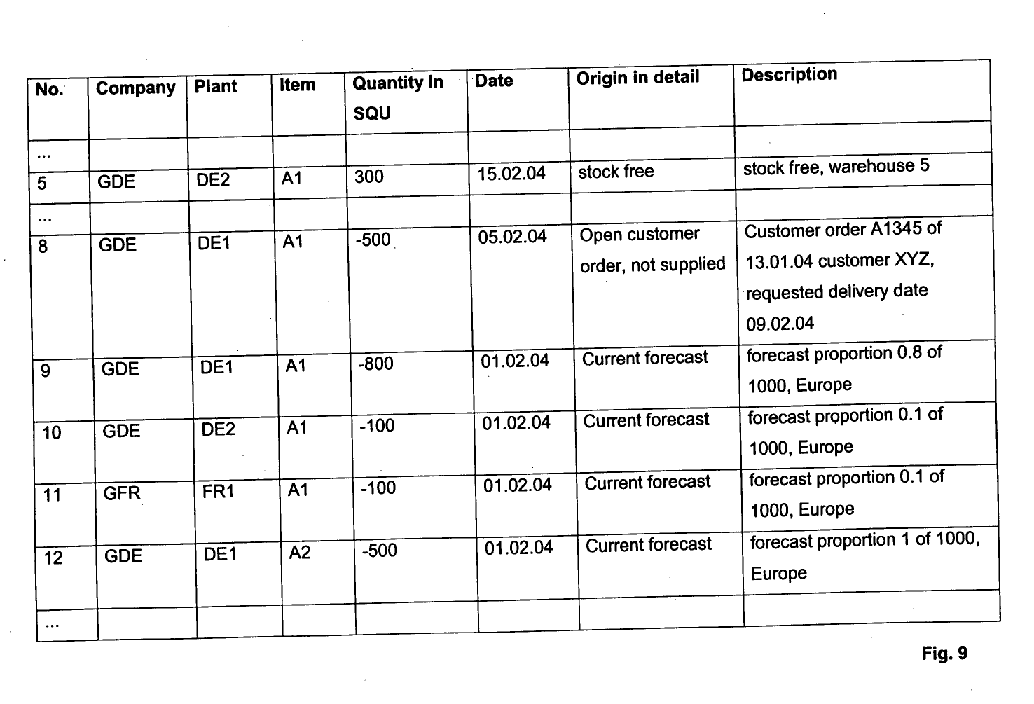

The core table after the inputting of the records from the forecast table is shown in FIG. 9.

When the records are input from the forecast table and additional table, the first record set from the forecast table regarding Item A1 in planning month 02.2004 gives the first three records in the core table. The forecast of 1000 kg is split according to the percentage amounts in the additional table.

As forecasts are provided only on a monthly basis but the core table requires a date, in the embodiment shown the quantity is distributed on the first of the month in each case. However, it is also possible to divide the forecast period into weeks or days. A similar procedure also takes place for example in budget figures which are generally given only on an annual basis. Here, too, the total budget is at least broken down into months. It is also possible to use an additional table which will include seasonal factors when the budget is divided up into months.

The data regarding Item A2 produce a single line in the core table as this item is produced in the plant DE1 in a proportion of 1.0 (i.e. exclusively).

The core table has been filled with records on the basis of three different system tables and one additional table. Other system tables, e.g. containing the planned production quantities or sales figures, are input analogously.

A major advantage of the process according to the invention is that records from all kinds of source system tables can be input into one table, the so called core table.

In a second processing step the core table is expanded by dimensions with the intention of producing a multi-dimensional data cube. Dimensions which are already known include for example time, organisation and materials, which are shown in the following tables:

Dimension Time:

| Date | Day | Week | Month | Quarter | Year |
|---|---|---|---|---|---|
| 01.05.2004 | 01 | 18 | 05 | 02 | 2004 |

Dimension Organisation:

| Company | Country | Region |
|---|---|---|
| GDE | DE | EUROPE |
| GFR | FR | EUROPE |

Dimension Material:

| | Item | | Product | | |
|---|---|---|---|---|---|
| Item | Description | Product | Group | Sales Group | Department |
| A1 | Soap | Soap | Curd | Washing | Toiletry |
| | Washing | Washing | Soaps | agents and | supplies |
| | Materials | Materials | | cleansers | |
| | 35 g | | | | |
| A2 | Washing lotion | Washing lotion | Liquid | Washing | Toiletry |
| | Superclean | Superclean | soaps | agents and | supplies |
| | 100 ml | | | cleaners | |

According to the invention the new dimensions of origin and time bar are supplemented. This is explained as follows.

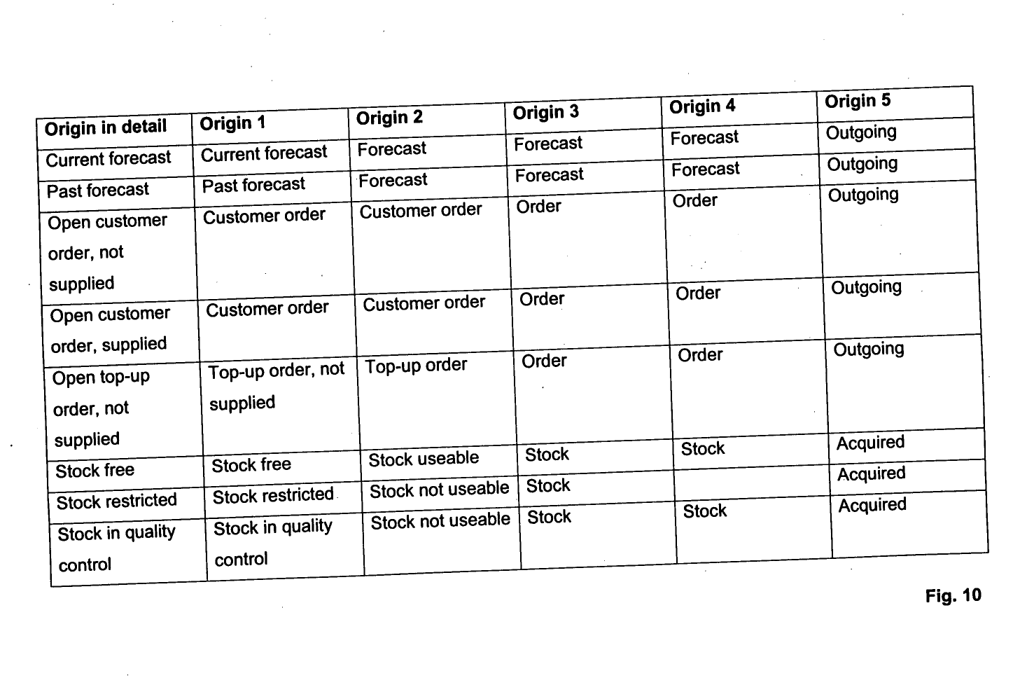

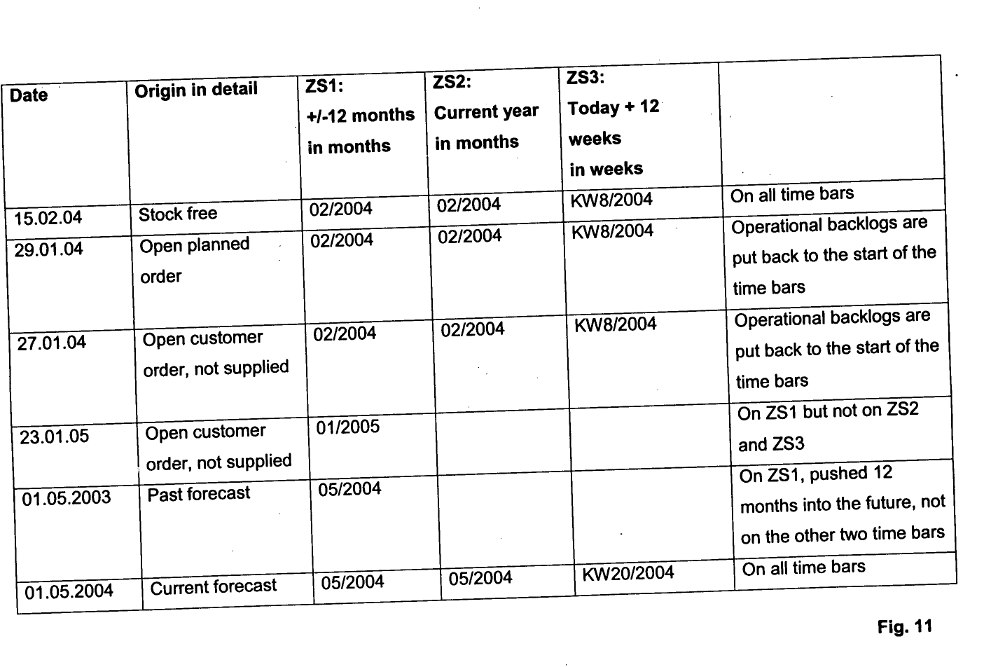

An example of the dimension origin is shown in FIG. 10. This dimension shows the origin of the corresponding entries or records in the core table and can be variably defined depending on the desired stage of compression and what is to be selected from the core table. If, in the embodiment given by way of example, the origin hierarchy 3 is selected, a distinction is drawn only between the forecast, stocks and orders. For example, the origin hierarchy 4 does not contain any restricted stocks.

As already explained, all the elements of the data cube may be assigned to different time bars according to a set of rules. To enable the past and future data to be understood at a glance, it is also possible to have time bars in which the future and past are superimposed. An element of the data cube which is shifted 12 months into the future, for example, must be given a suitable origin in the dimension origin, e.g. “forecast for previous year”. If all the time bars are the same length, it is easier to produce different views.

One example of the dimension “time bar” (starting from the crucial date of 15.02.2004) is shown in FIG. 11.

The data cube described provides raw data in the so called “back-end” system. In order to evaluate the records they are loaded once from the data cube into the so called front end system (e.g., application), i.e. the users computer, in a third processing step. The data displays are provided by means of an office software which the user runs on his front end system, e.g. using a table calculation programme such as Microsoft Excel®.

These evaluations are carried out according to the invention using firmly defined pivot tables (cross-tables from the table calculation) and adjacent calculation fields.

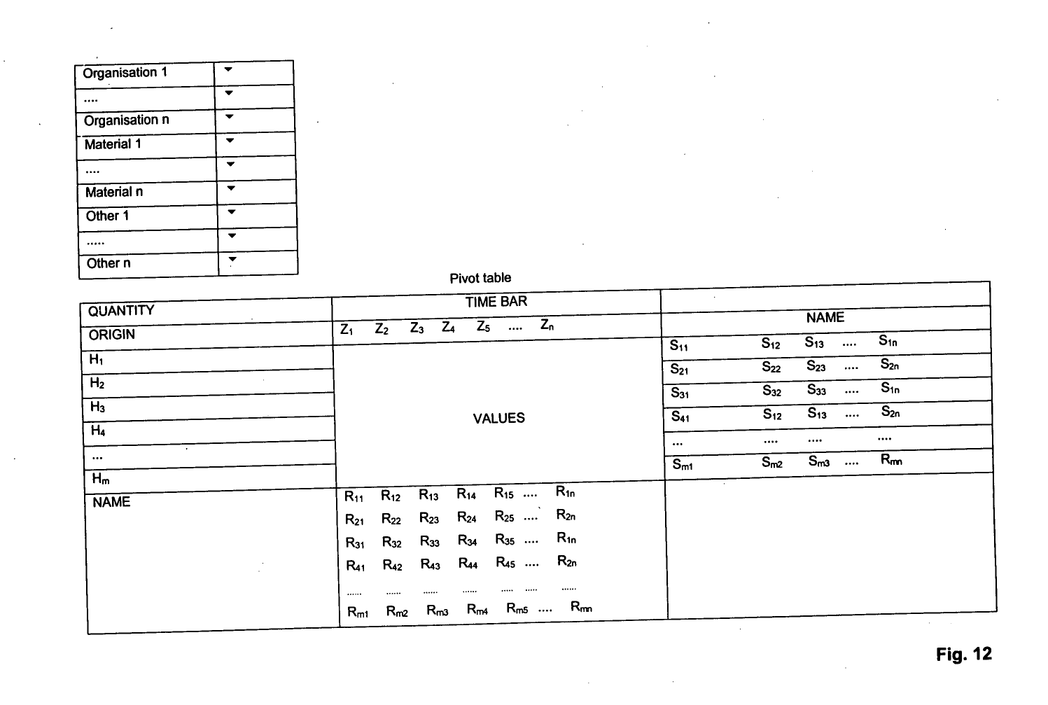

A possible embodiment is shown by way of example in FIG. 12, with a central pivot table, having a horizontally plotted time bar Z₁ to Zₙ and a vertically plotted origin H₁ to Hₘ. By restricting the dimensions of origin and time bar to specific selections it is ensured that the pivot tables are always the same size.

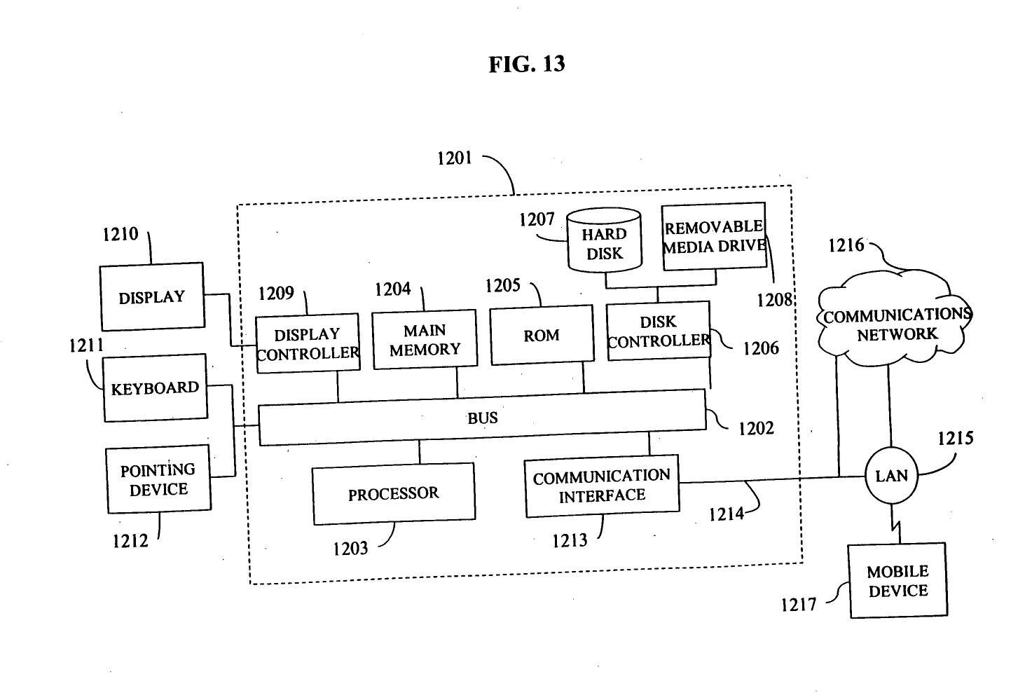

FIG. 13 illustrates a computer system 1201 upon which an embodiment of the present invention may be implemented. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 1201 may also include a display controller 1209 coupled to the bus 1202 to control a display 1210, such as a cathode ray tube (CRT), for displaying information to a computer user. The computer system includes input devices, such as a keyboard 1211 and a pointing device 1212, for interacting with a computer user and providing information to the processor 1203. The pointing device 1212, for example, may be a mouse, a trackball, or a pointing stick for communicating direction information and command selections to the processor 1203 and for controlling cursor movement on the display 1210. In addition, a printer may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204. Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media, volatile media, and transmission media. Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link 1214 that is connected to, for example, a local area network (LAN) 1215, or to another communications network 1216 such as the Internet. For example, the communication interface 1213 may be a network interface card to attach to any packet switched LAN. As another example, the communication interface 1213 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 maybe implemented in baseband signals, or carrier wave based signals. The baseband signals convey the digital data as unmodulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as unmodulated baseband data through a “wired” communication channel and/or sent within a predetermined frequency band, different than baseband, by modulating a carrier wave. The computer system 1201 can transmit and receive data, including program code, through the network(s) 1215 and 1216, the network link 1214 and the communication interface 1213. Moreover, the network link 1214 may provide a connection through a LAN 1215 to a mobile device 1217 such as a personal digital assistant (PDA) laptop computer, or cellular telephone.

This procedure according to the invention makes it possible to perform calculations on the surface of the front end system, while the data cube in the back end system provides the front end system with the necessary raw data. Calculations are then carried out solely on the surface of the front end system, as a result of which the process according to the invention provides individual, rapid and flexible evaluations. The graphical presentation of the data also takes place on the front end surface on the basis of once-fixed charts but which can still easily be altered.

The invention represents a clear departure from the usual methods used in data processing. In data warehouse systems, computing power occurs exclusively in back end systems the working memories of which are burdened with frequent data enquiries and calculations. Restricting a process to core data relevant to the planning process, loading all the data once into a front end surface and only in the front end system carrying out calculation processes for which no new server enquiries are required results in inexpensive, high speed and flexible enquiries and evaluations.

The advantages associated with the invention are thus:
An improvement in the planning processes as a result of simplified, central provision of planning-relevant data in a data cube;
As a result of the use of office software at the front end, maximum flexibility and data transparency at minimal cost;
The distribution of computing power over a number of front end servers or computers, thereby drastically reducing the waiting time for data evaluations.

German application No. 102004031931.6 filed on Jun. 23, 2004 is incorporated herein by reference in its entirety.

Obviously, numerous modifications and variations of the present invention are possible in light of the above teachings. It is therefore to be understood that within the scope of the appended claims, the invention may be practiced otherwise than as specifically described herein.

1-20. (canceled)

21. A computer-implemented business planning method, comprising the steps of:
inputting into a central table one or more first planning-relevant records from one or more data tables containing operational planning data;
generating a multi-dimensional data cube from the records inputted into the central table and storing the multi-dimensional data cube in a central memory of a computer network system; and
loading at least a portion of the data of the multi-dimensional data cube into a front end application to evaluate the data of the multi-dimensional data cube;
wherein the central table comprises at least one of a central quantity field and a central date field.

22. The computer-implemented business planning method of claim 21, wherein the one or more data tables are one or more system tables of an ERP System.

23. The computer-implemented business planning method of claim 21, wherein the central table comprises only a central quantity field, only a central date field, or only a central quantity field and a central date field.

24. The computer-implemented business planning method of claim 21, wherein inputting includes inputting only planning-relevant records into the central table.

25. The computer-implemented business planning method of claim 21, comprising inputting at least planning-relevant quantity data into the central quantity field of the central table.

26. The computer-implemented business planning method of claim 21, comprising inputting at least planning-relevant date data into the central date field of the central table.

27. The computer-implemented business planning method of claim 21, wherein one or more records having multiple relevance to planning are inputted more than once.

28. The computer-implemented business planning method of claim 21, further comprising:
adding an origin dimension to the central table to generate the multi-dimensional data cube.

29. The computer-implemented business planning method of claim 21, further comprising:
adding a time bar dimension to the central table to generate the multi-dimensional data cube.

30. The computer-implemented business planning method of claim 21, further comprising:
carrying out an evaluation of the data of the multi-dimensional data cube in a front end application wherein the data is in the form of a pivot table.

31. A computer program product including instructions encoded on a computer-readable medium and configured to enable a processor to perform a computer-implemented business planning method, comprising the steps of:
inputting into a central table one or more first planning-relevant records from one or more data tables containing operational planning data;
generating a multi-dimensional data cube from the records inputted into the central table and storing the multi-dimensional data cube in a central memory of a computer network system; and
loading at least a portion of the data of the multi-dimensional data cube into a front end application to evaluate the data of the multi-dimensional data cube;
wherein the central table comprises at least one of a central quantity field and a central date field.

32. The computer program product of claim 31, further comprising the step of:
adding an origin dimension to the central table to generate the multi-dimensional data cube.

33. The computer program product of claim 31, further comprising the step of:
adding a time bar dimension to the central table to generate the multi-dimensional data cube.

34. The computer program product of claim 31, further comprising the step of:
carrying out an evaluation of the data of the multi-dimensional data cube in a front end application wherein the data is in the form of a pivot table.

35. A system for implementing a business planning method, comprising:
means for inputting into a central table one or more first planning-relevant records from one or more data tables containing operational planning data;
means for generating a multi-dimensional data cube from the records inputted into the central table and storing the multi-dimensional data cube in a central memory of a computer network system; and
means for loading at least a portion of the data of the multi-dimensional data cube into a front end application to evaluate the data of the multi-dimensional data cube.

36. A computer-implemented system for implementing a business planning method, comprising:
a computer network system for entering one or more planning-relevant records into a central table;
a server having a memory storage device configured to store a multi-dimensional data cube derived from the central table;
a processor networked with the server and configured to be accessible to the memory storage device;
a front end application loaded in the processor and configured to evaluate the data of at least one of the central quantity field and the central date field.

37. The computer-implemented system of claim 36, wherein the one or more data tables are one or more system tables of an ERP System.

38. The computer-implemented system of claim 36, wherein the central table comprises only a central quantity field, only a central date field, or only a central quantity field and a central date field.

39. The computer-implemented system of claim 36, wherein inputting includes inputting only planning-relevant records into the central table.

40. The computer-implemented system of claim 36, comprising inputting at least planning-relevant quantity data into the central quantity field of the central table.

41. The computer-implemented system of claim 36, comprising inputting at least planning-relevant date data into the central date field of the central table.

42. The computer-implemented system of claim 36, wherein one or more records having multiple relevance to planning are inputted more than once.

43. The computer-implemented system of claim 36, further comprising:
adding an origin dimension to the central table to generate the multi-dimensional data cube.

44. The computer-implemented system of claim 36, further comprising:
adding a time bar dimension to the central table to generate the multi-dimensional data cube.

45. The computer-implemented system of claim 36, further comprising:
carrying out an evaluation of the data of the multi-dimensional data cube in a front end application wherein the data is in the form of a pivot table.
